(19) United States
(12) Patent Application Publication
(10) Pub. No.: US 2026/0358233 A1
(43) Pub. Date: Nov. 12, 2026

(54) Measurement Assembly, Method for the Real-Time Detection of Rheological Parameters of a Medium, and Processing Plant or Measurement Instrument Comprising At Least One Measurement Assembly

(71) Applicant: NETZSCH-Gerätebau GmbH, Selb (DE)

(72) Inventors: Rebekka Taubmann, Selb (DE); Sabrina Küspert, Selb (DE); Johannes Dunkel, Rehau (DE); Levente Szántó, Hof (DE); Onur Özgül, Nuremberg (DE); Christian Müller, Höchstädt (DE); Maximilian Reul, Marktleuthen (DE); Florian Rummel, Selb (DE)

(21) Appl. No.: 19/654,727

(22) Filed: Apr. 22, 2026

(30) Foreign Application Priority Data
May 6, 2025 (DE) 10 2025 117 316.8

(51) Int. Cl. G01N 15/1434; G06T 7/00; G06T 7/20; G01N 15/14

(52) U.S. Cl. CPC G01N 15/1434; G06T 7/0004; G06T 7/20; G01N 2015/1493; G01N 2015/1497; G06T 2207/10016; G06T 2207/30108

(57) ABSTRACT

A measurement assembly, including a measurement duct portion, which can be integrated into a processing plant or a measurement instrument and through which a medium can flow, wherein the measurement duct portion has at least one viewing window and at least one observation unit assigned to the viewing window, for optical detection of the medium. The invention also provides a method for the real-time detection of rheological parameters of a medium, and a processing plant or a measurement instrument including at least one measurement assembly.

### TECHINCAL FIELD

The present invention relates to a measurement assembly comprising a measurement duct portion, which can be integrated into a processing plant or a measurement instrument and through which a medium can flow, to a method for the real-time detection of rheological parameters of a medium in the measurement assembly, and to a processing plant or a measurement instrument comprising at least one measurement assembly.

In production lines or standalone (laboratory) measurement instruments that process flowable media, rheological measurement data of the medium are collected continuously and without interrupting the process via measurement assemblies integrated into the respective media lines. For example, in the chemical industry, the viscosity of, for example, paints, varnishes, adhesives or polymers is continuously monitored during production in order to ensure consistency and flow properties, while in the cosmetic industry, the flow properties and stability of cosmetic products such as shampoos, lotions and gels are monitored. The measurement assemblies, which can also be designed as standalone (laboratory) measurement instruments, collect characteristic rheological data, such as the viscosity of the medium, the shear rate, the density of the medium and the medium temperature, using a plurality of mechanical and electronic sensors in complex arrangements on or in the respective media lines. Conventionally, mechanical, sensor-assisted measurement methods are primarily used, wherein the characteristic data are derived from pressure differences, shear or rotation, such as in capillary-based or rotation-based rheometry systems and in miniaturized analysis devices, which are equipped with corresponding sensors and optical detection means, such as microchips or microfluidic systems. Alternatively, or additionally, vibration technologies can be used, which use resonant frequencies to determine the viscosity and density of the medium. It is also possible to take samples from the media flow at regular intervals and analyze the rheological properties thereof in separate instruments. A disadvantage of known rheometric measurement assemblies in media lines is that they take mechanical measurements as one- or two-point measurements without analyzing the flow profile or deformation profile of the medium in question. The separate analysis of individual samples is time-consuming and provides only a delayed indication of changes in the rheological properties.

### SUMMARY

The object of the present invention is therefore to create a structurally simple way of detecting rheological parameters of a medium and of deriving a plurality of characteristic rheological data on the basis of the detected parameters.

According to the invention, this object is achieved by the subject of the independent claims.

According to a first aspect of the invention, a measurement assembly is provided, comprising a measurement duct portion, which can be integrated into a processing plant or a measurement instrument and through which a medium can flow, wherein the measurement duct portion has at least one viewing window and at least one observation unit assigned to the viewing window, for optical detection of the medium. The detection is carried out in particular, in real time.

According to a second aspect of the invention, a method is provided for the real-time detection of rheological parameters of a medium in a measurement assembly, wherein the method comprises the steps of: optically detecting image or video sequences of a media flow passing the viewing window of the measurement duct portion by means of the observation unit; transmitting the detected image or video sequences to an evaluation unit; evaluating the detected image or video sequences to determine rheological parameters of the medium; and outputting a dataset characterizing the medium.

According to a third aspect of the invention, a processing plant or a measurement instrument is provided, comprising at least one measurement assembly as described above.

A concept on which the invention is based consists in optically detecting the structure of the medium during flow or at rest using a single measurement assembly during an ongoing process, for example in a processing production plant that processes flowable media or in a measurement instrument, and, on the basis of the detected flow profile, deformation profile or rest profile of the medium, quantifying one or more rheological variables, such as (shear) viscosity, extensional viscosity, shear stress, viscoelastic properties, storage modulus and/or loss modulus, computationally and in real time by image evaluation. Advantageously, the invention provides a measurement assembly for this purpose, in which only a purely optical detection of the medium and of structures entrained in dispersed systems, such as one or more particles, air bubbles or the like, takes place. In the method according to the invention, rheological measurement variables can then be derived solely by evaluating the collected optical data, i.e., by software-assisted analysis of the captured image or video sequences. At the same time or additionally, it is made possible to characterize dispersed systems and to detect various rheologically relevant system parameters by means of image processing. At the particle level, the characterization of one or more particle(s) entrained in the medium can be carried out in order to detect and evaluate various rheologically relevant particle parameters. By the optionally possible use of contrast agents added to the medium, the optical separation into different wavelength ranges can be improved, and the spectrum that can be detected in the image detection can be widened. A further advantage is that the measurement assembly is of a structurally simple design and has low susceptibility to faults.

Advantageous embodiments and developments can be found in the dependent claims, which refer to the independent claims, and in the description with reference to the figures.

According to one embodiment, the observation unit is designed as a camera device and/or microscope device, wherein the observation unit is configured in particular, for detecting movement parameters and/or deformation parameters of the medium or of at least one structure entrained in the medium. This advantageously allows the precise detection of movement parameters and deformation parameters of the medium or of structures and substructures entrained therein, such as particles, droplets or air bubbles, and of contrast agents or markers optionally added to the medium, and of phases in dispersions, and a more comprehensive and detailed detection of rheological parameters, which cannot be achieved using purely mechanical or one-point-based measurement methods. With the aid of the camera and/or microscope or a combination thereof, which is also covered by the invention, high-resolution image and video data are collected, which allow an analysis of flow profiles and deformation patterns of the medium in real time. Unlike in mechanical measurements, not only average values are detected but spatially and temporally resolved data are generated, which allows exact characterization of the medium. Furthermore, and additionally, particles in the medium can thus also be analyzed in terms of their size, shape, orientation, deformation and concentration on the basis of the image or video data, which proves advantageous in particular, in the analysis of dispersions, suspensions or multi-phase flows. The analysis of the phase distribution in dispersed systems is likewise possible on the basis of image or video data. The microscope device advantageously allows a detailed visualization of microstructures or phases in the medium, including the interaction between particles and the fluid and between the phases of dispersed systems. The combination of camera units and microscope units is particularly advantageous in the case of media with varying properties, such as non-Newtonian liquids, emulsions or suspensions. Advantageously, in addition to the determination of rheological variables such as viscosity or shear rate, it is thus also possible to analyze structural data such as phase separations, agglomerations or flow-induced microstructures. Examples which do not limit the invention of cameras and microscope units that can be used in the measurement assembly are briefly described below. In the measurement assembly according to the invention, standard cameras that detect high-resolution images and videos (CMOS or CCD) can be used. Alternatively, or additionally, for the analysis of fast flows or high- frequency oscillatory deformations or low-frequency oscillatory deformations or superimposed flows and oscillatory deformations, a high-speed camera can be used, which also allows a real-time observation of complex media with dynamic changes. The use of 3D camera systems, for example camera systems with stereo vision or confocal optical systems, is regarded as particularly advantageous for the detection of three-dimensional flow profiles, since these allow the analysis of particle movements in multiple spatial dimensions. For adaptation to the particular analysis protocol, it is also possible to design the camera as a fluorescence camera. In combination with fluorescent markers, specific particles or phases in the medium can thus be analyzed selectively, which is advantageous in particular, in biotechnological or pharmaceutical applications. In addition to those mentioned above, infrared cameras can also be used, which allow the observation of media that are not transparent in the visible range and can detect the thermal effects in the medium that influence rheological properties. Cameras with an additional thermal imaging function can also be used to detect the media temperature. Possible embodiments of the microscope units include, for example, optical microscopes for detecting detailed information about the microstructure of the medium, confocal microscopes, which allow the spatially resolved detection of microstructures and particles at depth in the medium, and fluorescence microscopes, which, in combination with fluorescent markers, allow the analysis of specific components or particles groups in the medium, in particular, in the analysis of biological or chemical samples. Optionally, a combination of the observation unit with at least one separate or integrated illumination unit is possible.

According to a development, the observation unit is configured for two- and/or three-dimensional detection of the movement parameters and/or deformation parameters. The possibility of detecting flows and deformation processes of the medium or of structures entrained therein in multiple dimensions advantageously extends the usability and accuracy of the measurement assembly according to the invention. While two-dimensional detection allows a simple and fast observation of flow profiles and deformation parameters in one plane, three-dimensional detection allows the complete spatial representation of the flow dynamics and deformation dynamics. This is particularly advantageous in the analysis of complex media with non-Newtonian behavior and with local variations in the flow. Three-dimensional detection provides additional information about shear rate distributions, flow effects at depth and interactive movements of structures, phases and/or particles, for example in the analysis of dispersions, suspensions, multi-phase flows and viscoelastic media. Three-dimensional detection allows the identification of rheological and structural parameters that are not accessible in purely two-dimensional systems, such as three-dimensional particle dynamics with analysis of orientation, deformation and interactions of particles, the calculation of the total flow volume, the derivation of a flow profile and the detection of the distribution of the particles in the flow volume and not just of surface effects, and the identification of gradients and irregularities in the overall flow cross-section.

According to one development, the observation unit is designed for fluorescence detection. Fluorescence detection advantageously allows the targeted investigation of specific constituents of the medium, such as fluorescently marked particles, contrast agents, markers, molecules or phases, and allows the analysis of complex systems such as dispersions, emulsions or multi-phase systems by highlighting certain analytes. In addition to the movement parameters and deformation parameters described above, fluorescent markers or contrast agents can also be used to analyze particle concentrations, diffusion rates, chemical reactions, phase separations and, in particular, in protein solutions, the protein distribution in the solutions, and to carry out protein identification.

According to a further embodiment, the measurement duct portion extends in a main movement direction of the medium. The measurement duct portion can advantageously be integrated seamlessly into media lines of existing processing plants or of measurement instruments without disrupting the flow. It is also advantageous that, thanks to the orientation of the measurement duct portion along the main movement direction, the flow profile of the medium is retained, and the data collected in the main flow direction reflects the real process conditions and in particular, can be transferred directly to a production process. The longitudinally oriented design of the measurement duct also minimizes eddies or turbulence and serves to avoid air bubbles, which could occur with transverse directions or deviating geometries. The arrangement integrated in the main movement direction also allows the continuous monitoring of rheological properties directly in the process flow without interruption, for example for taking samples for analysis in separate instruments.

According to a further embodiment, the measurement duct portion has a round, non-round, rectangular, polygonal or slot-shaped rectangular geometry. The selection of different cross-sectional geometries of the measurement duct portion advantageously allows an adaptation of the measurement assembly to the properties of the medium in question and to the requirements of the processing plant. Round cross-sections are primarily suitable for laminarly flowing media, which require a uniform flow. Non-round or rectangular or polygonal cross-sections simplify the arrangement of the viewing window, while in particular, slot-shaped rectangular cross-sections are particularly suitable for media with a low height, for example thin films, and allow an optimized analysis of the particles or flow of these media. Non-round geometries, in particular, with straight portions (for example rectangular cross-sections) allow the integration of flat viewing windows over the entire width of the measurement duct portion. Also covered by the invention, are measurement ducts or measurement duct portions in microfluidic measurement and analysis systems and miniaturized measurement and analysis chips/microchips.

According to a further embodiment of the measurement assembly according to the invention, the viewing window is arranged in the measurement duct portion flush with the surface or set back from the inner diameter of the measurement duct portion. The surface-flush arrangement advantageously reduces flow disruptions, since no geometric changes occur in the measurement duct, and ensures an undisrupted flow so that rheological parameters such as shear rate or viscosity can be measured under real process conditions. A set-back arrangement advantageously allows the investigation of normal stress effects, since this arrangement of the viewing window provides a geometry that causes so-called hole pressure effects and allows the investigation of normal stress components in the medium.

According to a development, an illumination unit is assigned to the viewing window and/or observation unit. Advantageously, an improved image quality is achieved by uniform and adjustable illumination of transparent, turbid and fluorescent media. As a result, the detailed analysis of particles, flow profiles and rheological parameters is improved, and fluorescence and 3D analysis methods are made possible, depending on the selected light source.

According to a further embodiment, two or more viewing windows are arranged in the measurement duct portion offset in a circumferential direction and/or longitudinal direction, and observation units assigned to the respective viewing windows are provided. The arrangement according to the preferred embodiment advantageously allows the simultaneous detection of flow parameters or deformation parameters from different angles. The arrangement in the flow direction advantageously allows the analysis of changes in the rheological properties of the medium, such as shear, deformation or relaxation, along the measurement duct portion. It can be considered a further advantage that the combination of viewing windows in the circumferential and longitudinal directions allows a quasi-three-dimensional analysis of the flow parameters and deformation parameters by corresponding combination or superimposition of the collected image data in the evaluation software and thus a complete spatial representation of the flow dynamics.

According to a development, an evaluation unit connected to the observation unit is provided. Advantageously, the collected image or video data are analyzed directly in the evaluation unit, and real-time detection and evaluation of rheological parameters such as viscosity, shear rate and particle movements are made possible. The analysis in real time allows production processes to be adapted immediately when there are deviations in the rheological properties. It is advantageous that the evaluation unit can carry out the interpretation of the optical data, for example by algorithms for image processing or by AI-assisted analysis, wherein complex evaluations, such as the determination of flow profiles, deformation patterns or particle behavior, are carried out efficiently in a software-assisted manner. The evaluation unit advantageously allows the calculation of specific rheological variables, including viscosity and shear rate, extensional viscosity and viscoelastic properties, but also of particle properties such as size, shape and concentration, on the basis of a purely optical detection of the medium. In addition to this, the evaluation unit can optionally be designed to detect further parameters detected as part of the analysis, such as the pH and temperature of the medium under investigation, and to include them in the calculation.

According to a further embodiment, the measurement duct portion is arranged in a media line of the processing plant or in a bypass line branched off from the media line. The positioning in the main media line advantageously allows a simple and direct detection of rheological parameters without additional line modifications, as a result of which space is saved and installation outlay is reduced. In addition, flow conditions of the medium remain unchanged in the main line, as a result of which measurement values are detected under realistic process conditions.

The alternative or additional arrangement of the measurement assembly in a branched-off line advantageously allows the targeted measurement of a portion of the medium without influencing the main process, wherein in particular, the flow speed and pressure conditions in the bypass line can be specifically adapted to create optimized measurement conditions for media with particular properties (for example high viscosity, particle load).

According to a development of the method, the evaluation comprises evaluating flow parameters and deformation parameters of the medium. Advantageously, information about the flow behavior and deformation of the medium going beyond simple viscosity measurement can thus be collected using purely optical input data. This allows an exact determination of rheological variables such as shear viscosity, extensional viscosity and viscoelastic properties.

According to a development of the method, the optical detection comprises detecting two- and/or three-dimensional image or video sequences of the media flow. Advantageously, two-dimensional image or video sequences are less computing- and memory-intensive than three-dimensional data and allow faster processing in real time. On the other hand, three-dimensional images advantageously allow a spatially complete analysis of flow processes and deformation processes with higher precision. Optionally, it is possible by using suitable contrast agents to improve the optical separation into different wavelength ranges and thus to widen the detectable spectrum, in particular, to beyond the spectrum visible to humans.

According to a development of the method, the optical detection comprises detecting image or video sequences of particles entrained in the medium or of at least one individual particle, wherein in particular, the evaluation of a particle shape, particle size, particle orientation, particle deformation, particle length, particle area and/or a volume of the particles or of the at least one individual particle and/or the particle number in the medium is provided. Advantageously, information about particle shape and size allows assessment of the interactions between at least one individual particle or multiple particles and the fluid that influence the rheological properties such as viscosity and shear behavior. The orientation and deformation of one or more particles allow the analysis of flow-induced microstructures that are decisive for the viscoelastic properties of the medium. Advantageously, the particle number and distribution can be used for an accurate description of the homogeneous or inhomogeneous distribution in dispersions, emulations or suspensions that have direct effects on flow properties. It is also advantageous that the particle deformation under flow permits information about elastic and plastic properties of the medium and about possible aggregation processes or dispersion processes. A volume and area analysis allows the calculation of the volumetric proportion of particles in the medium, whereby the relative viscosity or the shear stress can be determined.

According to a further embodiment, the evaluation of the detected image or video sequences comprises evaluating phase separations, in particular, in dispersed media. The evaluation of phase separations in dispersed media on the basis of the detected image or video sequences advantageously allows a precise analysis of the interactions between the phases and provides essential information for the rheological characterization, such as in particular, the detection and assessment of the dynamic stability, in particular, of dispersions, emulsions or multi-phase systems under flow-induced conditions. Advantageously, the information about changes in the phase separation allows conclusions to be drawn about the viscoelastic properties of the overall system, such as interphase shear stresses or the degree of dispersion.

The above embodiments and developments can be combined with one another as desired as far as is practical. Further possible embodiments, developments and implementations of the invention also comprise combinations not explicitly mentioned of features of the invention described previously or in connection with the exemplary embodiments below. In particular, a person skilled in the art will also add individual aspects as improvements or additions to the particular basic form of the present invention.

### BRIEF DESCRIPTION OF THE DRAWINGS

The present invention is explained in more detail below using exemplary embodiments with reference to the attached figures of the drawings. In the figures:

FIG. 1 shows a schematic diagram of a measurement assembly according to an exemplary embodiment of the invention;

FIG. 2 shows a schematic diagram of a measurement assembly according to a further exemplary embodiment of the invention;

FIG. 3 shows a schematic sectional diagram of a measurement assembly according to a further exemplary embodiment of the invention; and

FIG. 4 shows a flowchart of a method for the sequential analysis of individual samples in a rotation rheometer according to an exemplary embodiment of the present invention.

### DETAILED DESCRIPTION

In the figures of the drawings, identical, functionally identical and identically acting elements, features and components are each provided with the same reference signs, unless stated otherwise.

Although specific embodiments and developments are shown and described here, a person skilled in the art will prefer the fact that the specific exemplary embodiments shown and described can be replaced with a plurality of alternative and/or similar embodiments without departing from the scope of the present invention. This application is intended to cover generally all modifications or changes to the specific exemplary embodiments described herein.

The attached figures are intended to provide further understanding of embodiments of the invention and serve to explain principles and concepts of the invention in combination with the description. Other exemplary embodiments and many of the stated advantages are apparent from the drawings. The drawings should be understood only as schematic drawings, and the elements of the drawings are not necessarily shown true to scale relative to one another. Terminology indicating direction, such as "top", "bottom", "left", "right", "above", "below", "horizontal", "vertical", "front", ”rear,’’ and similar information, is used only for explanatory purposes and does not serve to limit the generality to specific embodiments as shown in the figures.

Dashed lines in the figures of the drawings indicate that the connections between the components linked by the dashed lines do not necessarily have to be in physical contact with one another but can equally be coupled to one another wirelessly.

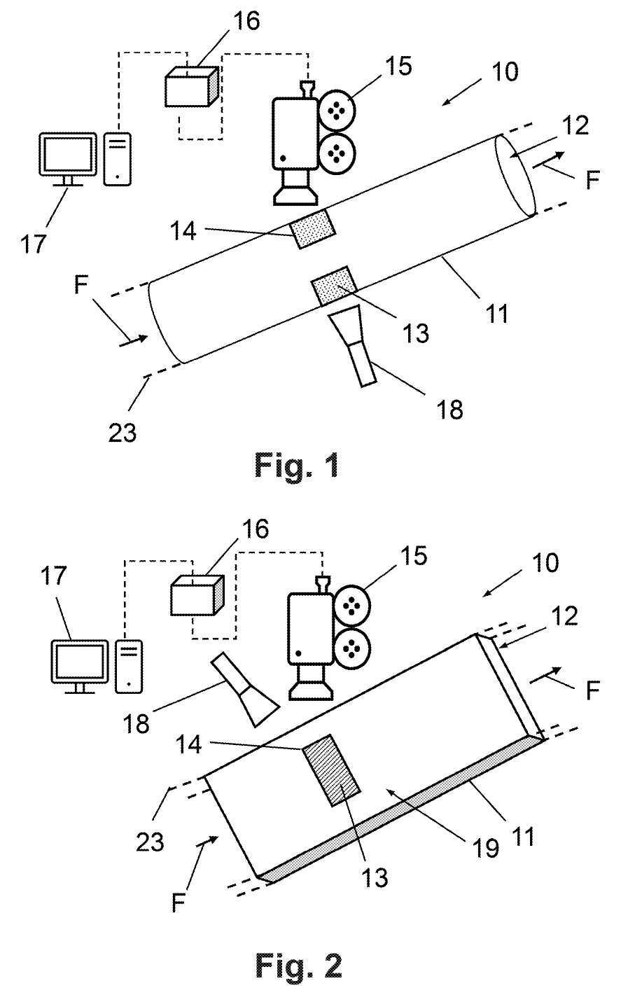

FIG. 1 shows a schematic diagram of a measurement assembly 10 according to an exemplary embodiment of the invention. The measurement assembly 10 shown is integrated as an inline rheometer in a processing plant. The measurement duct portion 11 has a round line cross-section 12, through which the medium 13, which can be seen through the viewing window 14, moves in a flow direction indicated by the arrow F. The measurement duct portion 11 is equipped with at least one viewing window 14, through which optical measurements of the flowing medium 13 are carried out. The viewing window 14 is assigned an observation unit 15, for example a camera unit and/or microscope unit, which is shown only in a highly schematic manner here. This observation unit 15 collects image or video data, which are used for the rheological analysis of the medium 13, including flow profiles, deformation parameters and particle movements.

The observation unit 15 is connected to an evaluation unit 16, which analyses the collected data. This evaluation unit 16 carries out a real-time analysis of the captured image data and/or video sequences and transmits the results to a computer 17, which carries out a representation of the measurement data and/or evaluations and optionally a direct display of the collected image data. Additionally, an illumination unit 18 is provided, which is arranged in the region of a viewing window 14 opposite the observation unit 15 and the light of which passes through the medium 13 and improves the quality of the optical detection. The exemplary embodiment presented shows a simple integration of the measurement duct portion 11 into an existing media line 23, whereby a continuous and disruption-free measurement is ensured during the ongoing process.

FIG. 2 shows a schematic diagram of a measurement assembly 10 according to a further exemplary embodiment of the invention, which is integrated as an inline rheometer in a processing plant. The measurement duct portion 11 shown, which is likewise integrated into a media line 23, has a rectangular line cross-section 12, which extends along the flow direction, indicated by the arrow F, of the medium 13, which can be seen through the viewing window 13. In the central region 19 of the rectangular measurement duct portion 11 there is a viewing window 14, which is inserted flush with the surface and ensures disruption-free flow of the medium 13. This viewing window 14 is manufactured from a transparent material that permits optical measurements with high accuracy. Alternatively, the viewing window 14 could also be arranged set back, which allows the investigation of hole pressure effects to analyze normal stresses in viscoelastic media.

The movement of the medium 13 that flows through the measurement duct portion 11 can be designed in different ways, for example flowing, i.e., in laminar, turbulent or secondary movement; oscillating, i.e., for the analysis of rest structures or dynamic relaxation effects, or dispersed, i.e., consisting of particles, phase boundaries or multi-phase systems. The measurement assembly 10 is equipped with an observation unit 15, which collects high-resolution image or video data of the medium 13 through the viewing window 14. The optical system of the observation unit 15 can be configured flexibly, for example as a confocal microscope for the three-dimensional microanalysis of flow profiles, particle dynamics and material structures; as a camera with a focusable optical system, wherein the focus can be directed to different planes of the medium 13 in order to allow a multi-dimensional detection of the flow; as a camera or microscope with fluorescence-based optical system in order, for example, to highlight and analyze specific constituents of the medium 13 using fluorescent markers. The image or video data collected by the observation unit 15 are analyzed by image-processing software in a connected evaluation unit 16 and forwarded to a computer 17 for storage, further evaluation and/or graphical preprocessing. In the exemplary embodiment of FIG. 2, to improve the quality of the optical detection, an illumination unit 18 is arranged next to the observation unit 15 and is directed towards the viewing window 14 and the media flow and illuminates them with light from above. The rheometric evaluations that can be carried out in the measurement assembly 10 comprise, for example, a particle analysis and characterization in terms of shape, size and orientation. The recognition and characterization of particles in the medium 13 provides detailed information about their behavior in the flow. Furthermore, an analysis of the distributions of number, length, area and volume can be carried out in order to assess the particle homogeneity and stability in the medium 13. The deformations of particles under shear stresses or normal stresses can also be analyzed, whereby conclusions can be drawn about the viscoelastic properties of the medium 13. The evaluation of phase boundaries in dispersed systems also allows the stability and dynamics of emulsions or suspensions to be assessed. It is also possible to detect and computationally assess flow parameters and deformation parameters, in order to analyze laminar-turbulent transitions or secondary flows, and structures and oscillating movements, in order to analyze the rest structure of the medium 13 and relaxation effects.

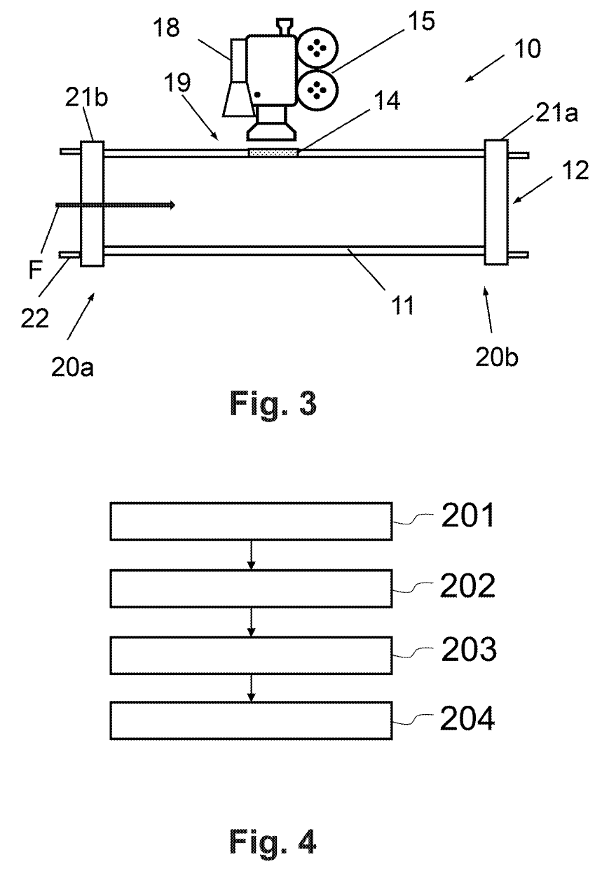

FIG. 3 shows a schematic sectional diagram of a measurement assembly 10 according to a further exemplary embodiment of the invention. The measurement assembly 10 is designed as an inline rheometer and can be integrated into a media line 23 (not shown in FIG. 3; cf. FIG. 1 and 2) of a processing plant. The measurement duct portion 11 is designed as a cylindrical tube with a round line cross-section 12, through which the medium is conducted in a predefined flow direction, indicated by the arrow F. The measurement duct portion 11 has, at its axial ends 20a, b, flanges 21a, b with connection bolts 22 arranged thereon for integration into a line system of a processing plant (not shown).

In the central region 19 of the measurement duct portion 11 there is a viewing window 14, which is inserted flush with the surface and allows a clear view of the flowing medium 13 (not shown in FIG. 3). The viewing window 14 is designed such that it does not disrupt the flow of the medium 13 and at the same time allows high-precision optical measurements. Alternatively, the viewing window 14 could also be arranged set back in this embodiment, in order to analyze normal stress effects by generating a hole pressure effect.

An observation unit 15, for example a camera or a microscope or a combination thereof, is attached directly above the viewing window 14 and is equipped with a high-resolution optical system. This optical system can be configured flexibly in order to meet different measurement requirements, as already described in connection with FIG. 2. The observation unit 15 is coupled to an illumination unit 18, which illuminates the medium 13 and the viewing window 14 in order to ensure optimal image quality.

FIG. 4 shows a flowchart of a method for the real-time detection of rheological parameters of a medium 13 in a measurement assembly 10 as described above. In the method, in step 201, image or video sequences of a medium 13 or media flow passing the viewing window 14 of the measurement duct portion 11 are optically detected by the observation unit 15. In the next step 202, the detected image or video sequences are transmitted to an evaluation unit 16. The transmission can take place wirelessly, for example via a W-LAN or Bluetooth connection, or in a wired manner between the observation unit 15 and the evaluation unit 16. Alternatively, the detected image or video sequences can also be transmitted directly via data connections to a server or to a data cloud and evaluated and/or stored there. In the step 203 following the transmission, the detected image or video sequences are evaluated to determine rheological parameters of the medium 13. The data of the evaluated image or video sequences are converted into a dataset and, in step 204, output as the dataset characterizing the medium 13 for further use in, for example, software for detail evaluation or graphical representation of the measurement results or for deriving further rheological parameters.

In the preceding detailed description, different features have been summarized in one or more examples to improve the cogency of the presentation. However, it should be clear that the above description is only of an illustrative nature and is not limiting. It serves to cover all alternatives, modifications and equivalents of the various features and exemplary embodiments. Many other examples will be immediately and directly clear to a person skilled in the art on viewing the above description, owing to the specialist knowledge of the person skilled in the art.

The exemplary embodiments were selected and described in order to present the principles on which the invention is based and their possibilities for use in practice in the best possible way. As a result, persons skilled in the art can optimally modify and use the invention and its various exemplary embodiments for the intended purpose. In the claims and the description, the terms "containing" and "having" are used as neutral terms for the corresponding term "comprising". Furthermore, the use of the terms "a" and "an" is not intended to exclude a plurality of features and components described in this way.

1. A measurement assembly, comprising a measurement duct portion, which can be integrated into a processing plant or a measurement instrument and through which a medium can flow, wherein the measurement duct portion has at least one viewing window and at least one observation unit assigned to the viewing window, for optical detection of the medium.

2. The measurement assembly according to claim 1, wherein the observation unit is designed as a camera device and/or microscope device, wherein the observation unit is configured, in particular, for detecting movement parameters and/or deformation parameters of the medium or of at least one structure entrained in the medium.

3. The measurement assembly according to claim 1, wherein the observation unit is configured for two- and/or three-dimensional detection of the movement parameters and/or deformation parameters.

4. The measurement assembly according to claim 1, wherein the observation unit is designed for fluorescence detection.

5. The measurement assembly according to claim 1, wherein the measurement duct portion extends in a main movement direction of the medium.

6. The measurement assembly according to claim 1, wherein the measurement duct portion has a round, non-round, rectangular, polygonal or slot-shaped rectangular geometry of the line cross-section.

7. The measurement assembly according to claim 1, wherein the viewing window is arranged in the measurement duct portion flush with the surface or set back from the inner diameter of the measurement duct portion.

8. The measurement assembly according to claim 1, wherein an illumination unit is assigned to the viewing window and/or observation unit.

9. The measurement assembly according to claim 1, wherein two or more viewing windows, which are arranged in the measurement duct portion offset in a circumferential direction and/or longitudinal direction, and observation units and/or illumination units assigned to the respective viewing windows are provided.

10. The measurement assembly according to claim 1, wherein an evaluation unit connected to the observation unit is provided.

11. The measurement assembly according to claim 1, wherein the measurement duct portion is arranged in a media line of the processing plant or of the measurement instrument, or in a bypass line branched off from the media line.

12. A method for the real-time detection of rheological parameters of a medium in a measurement assembly including a measurement duct portion, which can be integrated into a processing plant or a measurement instrument and through which a medium can flow, wherein the measurement duct portion has at least one viewing window and at least one observation unit assigned to the viewing window, for optical detection of the medium, the method comprising the steps of:
optically detecting image or video sequences of a media flow passing the viewing window of the measurement duct portion by means of the observation unit;
transmitting the detected image or video sequences to an evaluation unit;
evaluating the detected image or video sequences to determine rheological parameters of the medium; and
outputting a dataset characterizing the medium.

13. The method according to claim 12, wherein the evaluation comprises evaluating flow parameters and deformation parameters of the medium.

14. The method according to claim 12, wherein the optical detection comprises detecting two- and/or three-dimensional image or video sequences of the media flow.

15. The method according to claim 12, wherein the optical detection comprises detecting image or video sequences of at least one particle entrained in the medium, wherein the evaluation of a particle shape, particle size, particle orientation, particle deformation, particle number, particle length, particle area and/or a volume of the at least one particle in the medium is provided.

16. The method according to claim 12, wherein the evaluation of the detected image or video sequences comprises evaluating phase separations, in particular, in dispersed media.

17. A processing plant or measurement instrument comprising at least one measurement assembly, including a measurement duct portion, which can be integrated into a processing plant or a measurement instrument and through which a medium can flow, wherein the measurement duct portion has at least one viewing window and at least one observation unit assigned to the viewing window, for optical detection of the medium.

18. The measurement assembly according to claim 2, wherein the observation unit is configured for two- and/or three-dimensional detection of the movement parameters and/or deformation parameters.

19. The measurement assembly according to claim 2, wherein the observation unit is designed for fluorescence detection.

20. The measurement assembly according to claim 2, wherein the measurement duct portion extends in a main movement direction of the medium.
